(19) United States
(12) Patent Application Publication
(10) Pub. No.: US 2015/0156095 A1
(43) Pub. Date: Jun. 4, 2015

(54) CLOUD SYSTEM

(71) Applicants: Inventec (Pudong) Technology Corporation, Shanghai (CN); INVENTEC CORPORATION, Taipei (TW)

(72) Inventor: Ying-Chih LU, Taipei (TW)

(73) Assignees: Inventec (Pudong) Technology Corporation, Shanghai (CN); INVENTEC CORPORATION, Taipei (TW)

(21) Appl. No.: 14/246,929

(22) Filed: Apr. 7, 2014

(30) Foreign Application Priority Data
Nov. 29, 2013 (CN) 201310629903.1

(51) Int. Cl. H04L 12/26; H04L 12/911

(52) U.S. Cl. CPC H04L 43/0876; H04L 47/70

(57) ABSTRACT

A cloud system includes a resource module, a control module and a monitoring module. The control module electrically connected to the resource module is configured to control the resource module to adjust the cloud resource according to metric parameters and a resource request command. The monitoring module electrically connected to the resource module and the control module is configured to detect the resource module to produce metric parameters. The cloud system can further include an environment module and/or a power module. The module can monitor and detect at least one environment metric parameter. The control module can adjust the cloud resource according to at least one environment metric parameter.

### CROSS-REFERENCE TO RELATED APPLICATIONS

This non-provisional application claims priority under 35 U.S.C. §119(a) on Patent Application No. 201310629903.1 filed in People's Republic of China on Nov. 29, 2013, the entire contents of which are hereby incorporated by reference.

### TECHNICAL FIELD

This disclosure relates to a cloud system, particularity a cloud system for automatically adjusting the number of devices which provide services, and adjusting the power consumption.

### BACKGROUND

With the era of rapid development of information technology, e-business has become a trend, so that a general PC has been unable to meet the business needs. Therefore, servers with high computing capabilities are invented in order to meet the needs of e-business. Moreover, a single server system has gradually used to produce a large server system (or called as a container data center) with many single servers. The host of every single server will be placed in a rack system under the unified management of a system management terminal. Another container management controller in the server system of container data center managements all rack management controllers in all container data centers. Thus, the management and control of the number of severs enabled to provide services in multiple servers should be designed in order to have a high resource utilization rate.

### SUMMARY

According to one or more embodiments, the disclosure provides a cloud system which includes a resource module, a control module and a monitoring module. The resource module is configured to provide a cloud resource. The control module is electrically connected to the resource module and is configured to control the resource module to adjust the cloud resource according to metric parameters and a resource request command. The monitoring module is electrically connected to the resource module and the control module and is configured to detect the resource module to produce the metric parameters.

In one embodiment, the cloud system further includes an environment module and/or a power module. The power module is controlled by the control module to power at least one unit in the resource module. The environment module monitors and controls at least one environment metric parameter. The control module controls the resource module to adjust the cloud resource according to the at least one environment metric parameter.

### BRIEF DESCRIPTION OF THE DRAWINGS

The present invention will become more fully understood from the detailed description given herein below and the accompanying drawings which are given by way of illustration only and thus are not limitative of the present invention and wherein:

FIG. 1 is a function block diagram of a cloud system according to one embodiment;

FIG. 2A is a function block diagram of a control module according to one embodiment;

FIG. 2B is a function block diagram of an auto cloud provision module according to one embodiment;

FIG. 2C is a function block diagram of a cloud service provision module according to one embodiment;

FIG. 2D is a function block diagram of a virtual resource provision module according to one embodiment; and

FIG. 3 is a function block diagram of a monitoring module according to one embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

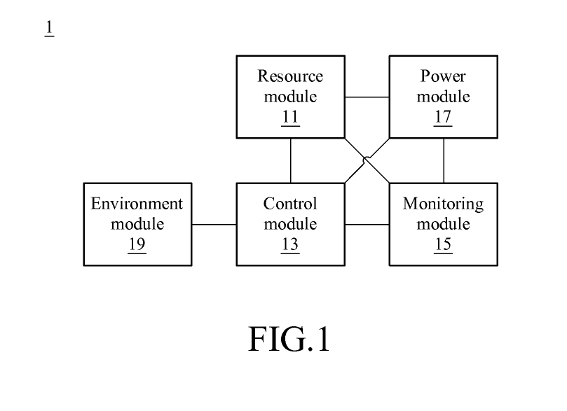

FIG. 1 is a function block diagram of a cloud system according to one embodiment. The cloud system 1 includes a resource module 11, a control module 13 and a monitoring module 15. These three modules are electrically connected to each other.

The resource module 11 is configured to provide cloud resources. For example, the cloud resources include a computing resource, a storage resource and a communication resource. In one or more exemplary embodiments, the resource module 11 includes at least one computing unit, at least one storage unit and at least one communication unit. In one of the exemplary embodiments, the computing unit supports a computing resource with a specific computing throughput measured with a quantity of commands per second, the storage unit provides a storage resource with a specific capacity measured with million bytes or similar unit, and the communication unit provides a communication resource with a specific transmission throughput measured with kilo-byte per second (kBps). Specifically, the computing unit is, for example, an application-specific integrated circuit (ASIC), an advanced RISC machine (ARM), a central processing unit (CPU), a single chip controller or a device including the aforementioned elements. The storage unit is, for example, a flash memory, a hard disk drive, an electrically-erasable programmable read-only memory or an electric device including the aforementioned elements.

In one embodiment of the resource module 11, the computing unit, the storage unit and the communication unit can have different types. For example, the computing unit can be a floating point operation unit, an arithmetical logic unit or a unit for the coordination transformation or the graphic processing. The storage unit can be, for example, a non-volatile memory (e.g. a hard disk drive or a flash memory) or a volatile memory (e.g. a static random access memory (SRAM) or a dynamic random access memory (DRAM)).

In an alternative embodiment of the resource module 11, the resource module 11 includes multiple units including a first unit and a second unit, and each of the units provides different resources. For example, the first unit can support one million times floating point operation (or called as floating point arithmetic, FPA) per second and include a non-volatile memory of five terabytes volume and a volatile memory of two billion bytes volume at the same time. For example, the second unit can support eight hundred thousand times floating point operation per second and one hundred thousand times integer operation and include a non-volatile memory of two terabytes volume and a volatile memory of three billion bytes volume. Assume the power consumption of the first unit sufficiently equals to the power consumption of the second unit. The first unit has higher priority than the second unit to be selected to perform floating point operation, and the second unit has a higher priority than the first unit to be selected to perform integer operation.

The control module 13 is configured to control the resource module 11 to adjust the cloud resources according to metric parameters and resource request commands. The metric parameter is a generalized measurement value, e.g. a performance value, a storage volume, a network bandwidth value, an environment metric parameter (e.g. a voltage value, a current value, a humidity value or a temperature value) for machine operating, a quantity of errors (e.g. a quantity of correctable errors, or a quantity of uncorrectable errors), or a measurement value for executing software. In one exemplary embodiment, when the control module 13 receives a resource request command, the control module 13 calculates the sum of cloud resources corresponding to the resource request command and, according to at least one metric parameter, determines whether the at least one cloud resource provided by the resource module 11 satisfies the resource request command. Specifically, according to the resource request command and the at least one metric parameter, the control module 13 determines that the number of units (e.g. at least one computing unit, at least one storage unit and at least one communication unit) in the resource module 11 should be enabled to provide at least one cloud resource matching the resource request command. The control module 13 and at least one unit (or at least one module) are, for example, application-specific integrated circuits (ASIC's), advanced RISC machines (ARM's), central processing unit (CPU's), single chip controllers, devices including the aforementioned elements, or software executed on a physical computing device.

In one embodiment, if the control module 13 receives a resource request command and, according to the at least one metric parameter, determines that the at least one cloud resource provided by the resource module 11 can't satisfy the resource request command at a certain time, the control module 13 defines this situation to be a bottleneck event and records the resource request command. In this way, the next time the control module 13 can determine that the same bottleneck event may occur as receiving the same resource request command again.

In other embodiment, the control module 13 records resource request commands which are last received before a bottleneck event is happened, and employs these recorded resource request commands to check whether a bottleneck event is happened or not when the next time a new resource request command is received. For example, the control module 13 sorts last ten resource request commands, which are received before a previous bottleneck event is happened, based on the sequence of receiving these resource request commands. Once the control module 13 receives top five of the recorded ten resource request commands again, the control module 13 will be able to determine that a bottleneck event may be happened in the cloud system 1 again, and control the resource module 11 to provide more cloud resources to avoid the happening of the bottleneck event.

The monitoring module 15 is configured to detect the resource module 11 to produce metric parameters. Specifically, the monitoring module 15 monitors the operation states of every unit in the resource module 11 providing at least one cloud resource, quantifies these operation states to generate the metric parameters, and submits the metric parameters of every unit to the control module 13. Therefore, the control module 13 can manage every unit in the resource module 11 according to the metric parameters of every unit. For example, if the computing ability of one unit in the resource module 11 suddenly decreases, the monitoring module 15 transmits metric parameters of this unit to the control module 13 so the control module 13 can determine that this unit may have a failure event. Since the computing ability of the unit, which has the failure event, decreases, the unit cost will rise if this unit is continuously used. Thus, the control module 13 can control the resource module 11 to use another unit to replace this unit. Also, a maintainer can replace or fix one or more units in real time when knowing that one or more failure events occur in the one or more unit according to the record in the control module 13.

In one embodiment, the cloud system 1 further includes the power module 17, which is electrically connected to the resource module 11 and the control module 13. The power module 17 includes a plurality of power units. Every power unit is electrically connected to one or more computing units, storage units or communication units in the resource module 11, and is also electrically connected to the control module 13. The power module 17 is controlled by the control module 13 to power at least one unit in the resource module. The monitoring module 15 monitors the power units and transmits metric parameters of every power unit to the control module 13.

In one embodiment, the cloud system 1 further includes an environment module 19, which is electrically connected to the control module 13 in order to monitor and control at least one environment metric parameter. For example, the environment metric parameter may be, but not limited to, the temperature, humidity, current, voltage, and system invasion related to the resource module 11 and/or the power module 17. In this embodiment, the control module 13 can record the environment metric parameters when the bottleneck event or failure event occurs, and determine whether the bottleneck event or failure event will occur in the future, according to the recorded environment metric parameters.

For example, since the resource request command transmitted during the usage of the cloud system 1 usually occurs periodically, the bottleneck event may also occur periodically. The control module 13 determines whether a specific bottleneck event occurs periodically, and determines possible time points that the next time the same bottleneck event is going to occur, by using the time information. For example, since the units in the resource module 11 are embodied by electrical components, the efficiency of the electrical components may decrease under the high temperature/humidity environment, thereby possibly causing a failure event. Therefore, the control module 13 can record the temperature and the humidity when the failure events occur, and can figure out any possible temperature and humidity related to the failure event by using the related statistics. The control module 13 can further record the temperature and humidity of every unit periodically or non-periodically to determine the relationship between the environmental factors (e.g. the temperature and the humidity) and metric parameters of every unit. Therefore, the control module 13 can adjust the number of units in the resource module 11 which are enabled to provide cloud resources according to the temperature and the humidity, so that the chance of the bottleneck event occurring can be decreased. When the control module 13 receives metric parameters which are provided by the environment module 19 and are out of the normal range or close to the edge of normal range, the control module 13 will attempt to command the environment module 19 to control metric parameters back to the normal range, or will attempt command the resource module 11 and the power module 17 to improve metric parameters or disable some of the resource functions.

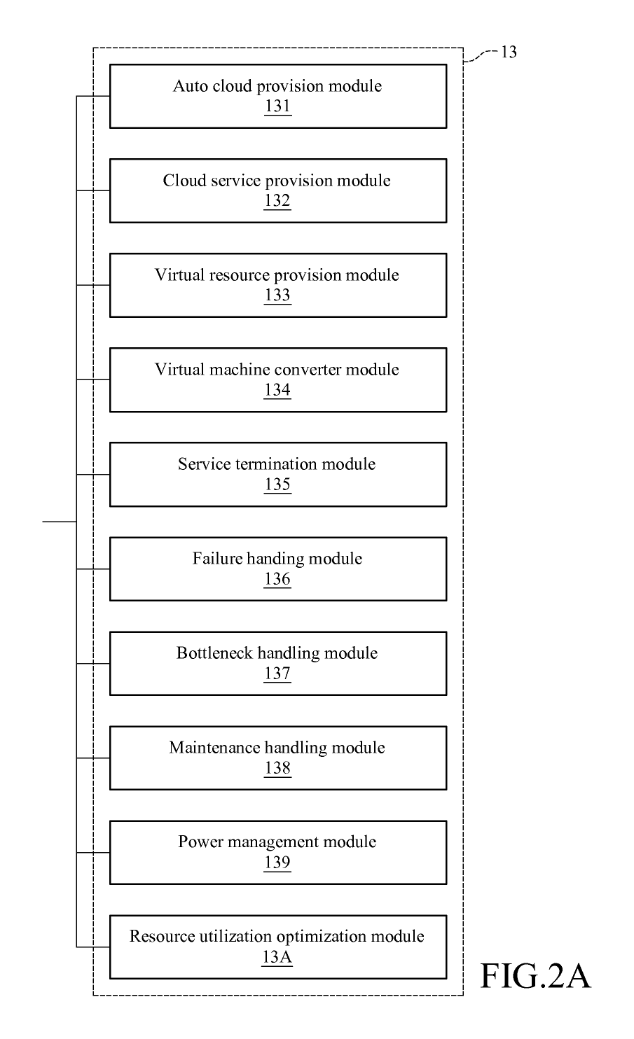

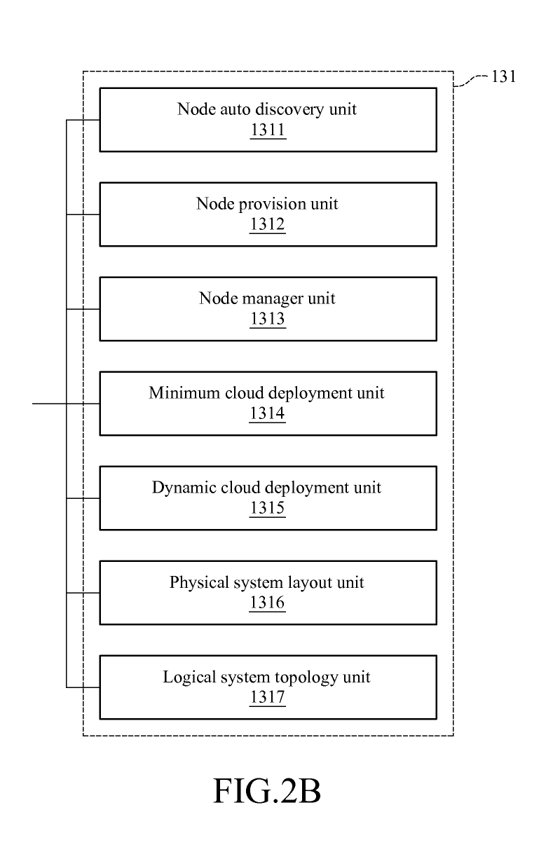

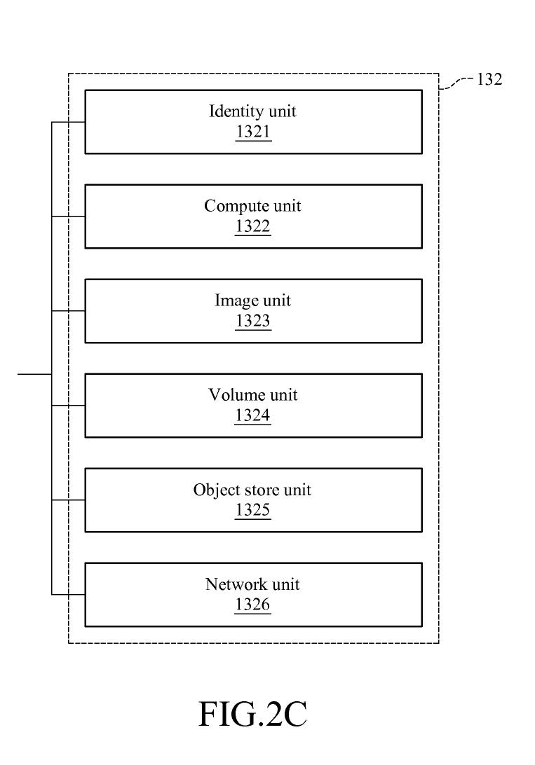

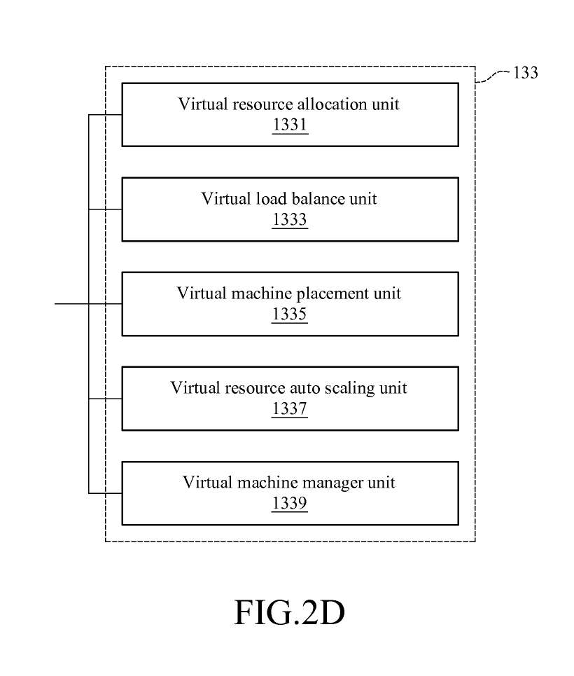

FIG. 2A is a function block diagram of a control module according to one embodiment. As shown in FIG. 2A, the control module 13 includes an auto cloud provision module (ACP) 131, a cloud service provision module (CSP) 132, a virtual resource provision module (VRP) 133, a virtual machine converter module (VMC) 134, a service termination module (ST) 135, a failure handing module (FH)136, a bottleneck handling module (BH) 137, a maintenance handling module (MH) 138, a power management module (PWM) 139, and a resource utilization optimization module (RUO) 13A.

FIG. 2B a function block diagram of an auto cloud provision module according to one embodiment. As shown in FIG. 2B, the auto cloud provision module 131 includes a node auto discovery unit (NAD) 1311, a node provision unit (NP) 1312, a node manager unit (NM) 1313, a minimum cloud deployment unit (MCD) 1314, a dynamic cloud deployment unit (DCD) 1315 (or called on-demand cloud deployment unit), a physical system layout unit (PSL) 1316, and a logical system topology unit (LST) 1317.

The node auto discovery unit 1311 automatically detects at least one unit in the resource module 11 for providing them with cloud resources, and starts the detected units to get hardware information of the detected units and then categorize the detected units. For example, the detected unit can be respectively categorized by the node auto discovery unit 1311 into a storage unit, a computing unit, or a communication unit. Furthermore, the node auto discovery unit 1311 provides the data of the detected units to the node provision unit 1312, the physical system layout unit 1316, and the logical system topology unit 1317.

The node provision unit 1312 obtains the data of the detected units in the resource module 11 from the node auto discovery unit 1311, and selectively controls the configuration (executing status) of the detected units to achieve the best efficiency of using the cloud resources. The node manager unit 1313 controls whether the detected units in the resource module 11 should be enabled, disabled, restarted, reset, reinstalled or isolated.

The minimum cloud deployment unit 1314 is configured to control the node provision unit 1312 to enable a certain amount of computing units, storage units and communication units in the resource module 11 to normally provide cloud services. Thus, the cloud system 1 can provide at least basic cloud services at any time. The dynamic cloud deployment unit 1315 determines the number of units providing the cloud services in resource module 11 and controls the node provision unit 1312 according to the metric parameters and resource request command to enable these units in the resource module 11.

The physical system layout unit 1316 obtains the physical address (for example, the physical location of physical machines and network equipment in the data center, such as the location of container, the location of slots, the location of device, and the location of frame) of each unit in the resource module 11 from the node auto discovery unit 1311. The logical system topology unit 1317 obtains the path between an input/output router and every unit in the resource module 11 from the node auto discovery unit 1311. Therefore, the minimum cloud deployment unit 1314 and the dynamic cloud deployment unit 1315 may determine which unit in the resource module 11 should be enabled to provide cloud resources, according to the records which are related to the paths between the input/output router and the units in the resource module 11 and are stored in the physical system layout unit 1316 and the logical system topology unit 1317.

The cloud service provision module 132 is configured to provide an application interface for users to obtain the needed cloud resource from the cloud system 1 according to their categories (e.g. normal users or testers). FIG. 2C is a function block diagram of a cloud service provision module according to one embodiment. As shown in FIG. 2C, the cloud service provision module 132 includes an identity unit 1321, a compute unit 1322, an image unit 1323, a volume unit 1324, an object store unit 1325, and a network unit 1326.

An identity unit 1321 is configured to authorize users and establish the data for users and tenants. For example, when there is a new tenant using the cloud system 1, the identity unit 1321 will establish the data for the tenant. Then, the identity unit 1321 determines how to allocate the corresponding image of virtual machine (VM) and the cloud resource according to the property of user (a normal use or a tester) and the property of the tenant which this user belongs to, when the user of this new tenant accesses the cloud system 1 for the first time.

When there is a user entering the cloud system 1, the compute unit 1322 may render the size of virtual CPU corresponding to the user, the memory volume corresponding to the user, the image corresponding to the virtual machine, and the storage space corresponding to the virtual machine according to a virtual machine accessing key of the user. The virtual machine accessing key records the property of the user and the tenant belonged to the user, such as the department, the main business, or the cloud services in common use. Therefore, the compute unit 1322 can render the size of virtual CPU corresponding to the user, the memory volume corresponding to the user, the image corresponding to the virtual machine, and the storage space corresponding to the virtual machine according to the above information, and can allocate the corresponding virtual machine for the units in the resource module 11.

The image unit 1323 and the volume unit 1324 are configured to know the information about an image file and a storage space corresponding to the virtual machine relative to the user, to obtain the image file from the object store unit 1325 and allocate the corresponding storage units from the units of the resource module 11 corresponding to the storage space. The network unit 1326 establishes the firewall for the user's virtual machine and renders the virtual machine a world-wide web protocol address and a private internet protocol address.

The virtual resource provision module 133 is configured to manage virtual resources, such as a virtual machine, a virtual cluster (VC) and a virtual data center (VDC). FIG. 2D is a function block diagram of a virtual resource provision module according to one embodiment. As shown in FIG. 2D, the virtual resource provision module 133 includes a virtual resource allocation unit (VRA) 1331, a virtual load balance unit (VLB) 1333, a virtual machine placement unit (VMP) 1335, a virtual resource auto scaling unit (VAS) 1337, and a virtual machine manager unit (VMM)1339. The virtual resource allocation unit 1331 is configured to get virtual resources from the cloud system 1. The virtual load balance unit 1333 is configured to balance loading of virtual machines in the virtual cluster. The virtual machine placement unit 1335 is configured to, according to the virtual cluster policy and/or the virtual machine policy, decide which one of physical units (or called physical hosts) every virtual machine is allocated to. For example, the virtual cluster policy is the safe priority, the upload priority, the download priority, or the high efficient calculation priority. The virtual resource auto scaling unit 1337 is configured to dynamically adjust the sizes of virtual machine, virtual cluster, and virtual data center. The virtual machine manager unit 1339 is configured to manage every virtual machine.

The virtual machine converter module 134 is configured to transform images of virtual machines with different formats and their configuration files into the formats and configuration files which are adapted to the cloud system 1. For example, the cloud system 1 includes many types of clouds, and every cloud executes different types of virtual machine (with different formats). When one virtual machine is executed, the virtual machine converter module 134 finds a suitable cloud for the virtual machine. For example, the virtual machine converter module 134 transforms the format of a virtual machine and its configuration file into the format of the current virtual machine and the current configuration file executed in the cloud system 1.

When one virtual machine stops or one user stop using the cloud service, the service termination module 135 will release the cloud resource (like a virtual machine, virtual cluster, and etc) occupied by this user or this virtual machine, to the cloud system 1.

When the failure handing module 136 detects a failure event from a physical machine, a virtual machine, a network equipment, a non IT device, a software service or a power source, the failure handing module 136 will try to bring the cloud system 1 back to normal by resetting or deleting the hardware or software with errors.

The bottleneck handling module 137 is configured to record, determine whether a current bottleneck event (like the computing throughput, storage volume or network bandwidth of physical device, of physical device pool, of virtual device, or of virtual device pool) occurs, or predict an upcoming bottleneck event. When the current bottleneck event occurs, the bottleneck handling module 137 will try to eliminate it appropriately. Before the upcoming bottleneck event occurs, the bottleneck handling module 137 notifies the control module 13 to control the resource allocation in the cloud system 1, to prevent the cloud system 1 from the upcoming bottleneck event. The maintenance handling module 138 also determines whether there is a current failure event or an upcoming failure event, eliminates the current failure event from the cloud system 1, and adds cloud resources appropriately to prevent the cloud system 1 from the upcoming failure event according to the operation logs of the cloud system 1. In this way, the cloud system 1 may be prevented from any failure events when the user is using the cloud system 1.

The power management module 139 saves power for the cloud system 1 according to a power policy. For example, when an operation capability of a device isn't used completely or the device is idle, the power management module 139 will turn off the device, reduce the operating frequency of the device (such as the control of power-performance or terminal-throttling of CUP), limit the maximum power budget of the device or a physical machine load balance, or decrease the power usage efficiency of the cloud system 1.

The resource utilization optimization module 13A is configured to make the usage of resource in the cloud system 1 efficient through, for example, the over-commit technology. For example, when the need of virtual resources (like a virtual machine, a virtual machine cluster and a virtual data center) is greater than the capacity of physical resources (like a physical machine, a calculating pool, a storage pool, a network pool and a data center), the over-commit technology allows the virtual resources to normally operate and satisfy the principle of service level agreement because the over-commit technology can predict the behavior of the virtual resources and these virtual resources don't use their maximum capability at the same time. Specifically, the resource utilization optimization module 13A gets the operation history of the virtual resources from the monitoring module 15 to analyze the upcoming behavior of the virtual resources by the data mining to realize the virtual resources on the appropriate physical devices in advance.

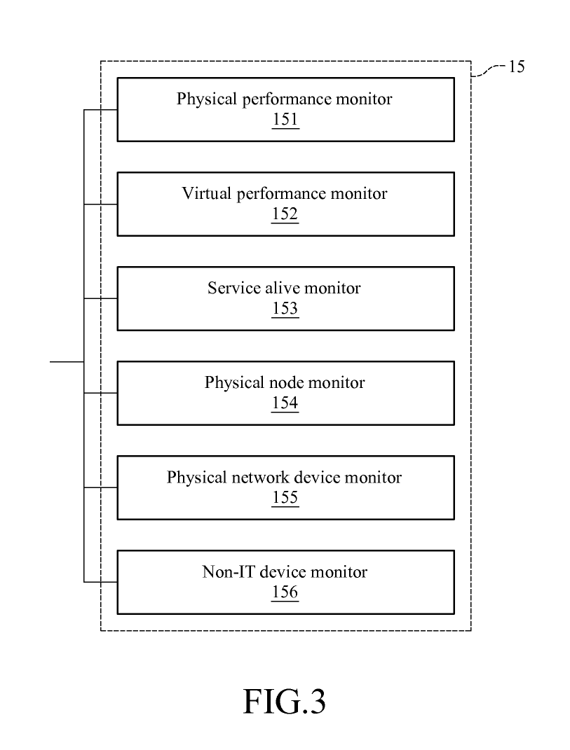

FIG. 3 is a function block diagram of a monitoring module according to one embodiment. As shown in FIG. 3, the monitoring module 15 includes a physical performance monitor (PPM) 151, a virtual performance monitor (VPM) 152, a service alive monitor (SAM) 153, a physical node monitor (PNM) 154, a physical network device monitor (PNDM) 155 and a non-IT device monitor (NIM) 156.

The physical performance monitor 151 and the virtual performance monitor 152 get metric parameters of physical units (e.g. computing units, storage units and communication units) and virtual machines according to the sampling flow protocol and provide the metric parameters to the bottleneck handling module 137, and according to the metric parameters, the bottleneck handling module 137 determines whether any bottleneck event is happened or will be happened. The service alive monitor 153 gets metric parameters of cloud services and provides them to the maintenance handling module 138, and according to the metric parameters of cloud services, the maintenance handling module 138 determines whether cloud software services are normal or not. The physical node monitor 154 and the physical network device monitor 155 get metric parameters of physical units and physical network equipment and provide them to the failure handing module 136, and according to the metric parameters of physical units and physical network equipment, the failure handing module 136 determines whether any failure event has occurred or will occur in the physical units or the physical network equipment. The non-IT device monitor 156 is configured to get metric parameters of other units (such as power units of the power module 17 and the environment module 19) and provides them to the control module 13, and according to the metric parameters of other units, the control module 13 determines whether any failure event occurs in the power units.

The aforementioned function blocks (i.e. modules or units) in FIG. 2A, FIG. 2B, FIG. 2C, FIG. 2D and FIG. 3 can be physical computing devices or be daemons executed in a computing device. Every daemon has an application programming interface (API) of its export for other daemons to call them. The application programming interface of every daemon can be embodied by a transfer control protocol and internet protocol (TCP IP) socket or a user defined protocol and internet protocol (UDP IP) socket. The socket of every daemon has a port number. Every daemon can be executed in different physical machines or virtual machines. The communication between daemons is based on the daemon socket API's and can support the remote procedure call (RPC). The cloud system 1 can be embodied by one or more function blocks (modules or units) cooperating with daemons and application programming interfaces. The cloud system 1 has a node lock mechanism to eliminate conflict from the node operation between nodes.

The modules and units of the control module 13 and the monitoring module 15 may be physical computing devices (such as computers or servers) or programs executed in a physical device.

In view of the aforementioned description in the disclosure, the cloud system includes the resource module, the control module, the monitoring module, the power module and the environment module. The control module can determine whether cloud resources provided by the resource module satisfy a resource request command, according to metric parameters of the resource module and the power module obtained by the monitoring module and the environment metric parameters obtained by the environment module. The control module also determines the occurring of bottleneck events (which are caused because cloud resources can't satisfy a resource request command) and failure events to prevent the cloud system from bottleneck events and failure events.

What is claimed is:

1. A cloud system, comprising:
a resource module configured to provide a cloud resource;
a control module electrically connected to the resource module, and configured to control the resource module for adjusting the cloud resource according to metric parameters and a resource request command; and
a monitoring module electrically connected to the resource module and the control module, and configured to detect the resource module to produce metric parameters.

2. The cloud system according to claim 1, wherein the control module determines whether the cloud resource satisfies the resource request command or not, according to the metric parameters to control the resource module to adjust the cloud resource.

3. The cloud system according to claim 2, wherein the resource module comprises:
a plurality of computing units electrically connected to the control module, and respectively configured to provide a computing resource when being enabled;
a plurality of storage units electrically connected to the control module, and respectively configured to provide a storage resource when be enabled; and
a plurality of communication units electrically connected to the control module, and respectively configured to provide a communication resource when being enabled;
wherein the cloud resource comprises the computing resource, the storage resource and the communication resource.

4. The cloud system according to claim 3, wherein the control module adjusts numbers of the computing units, the storage units and the communication units which are enabled when the cloud resource doesn't satisfy the resource request command.

5. The cloud system according to claim 4, wherein the control module records relationship between the resource request command and the numbers of the computing units, the storage units and the communication units which are enabled in the resource module to generate a resource reference table.

6. The cloud system according to claim 5, wherein the control module determines whether the cloud resource satisfies the resource request command or not, according to the resource reference table after a default time.

7. The cloud system according to claim 3, further comprising a power module electrically connected to the resource module and the control module, and comprising a plurality of power units, and respectively electrically connected to the control module, at least one of the computing unit, the storage unit or the communication unit and the control module, which is configured to control the control module to provide power.

8. The cloud system according to claim 7, wherein the control module controls a number of the power units, enabled to provide power, in the power module according to the numbers of the computing units, the storage units and the communication units which are enabled in the resource module.

9. The cloud system according to claim 1, further comprising: a environment module electrically connected to the control module and configured to monitor and control at least one environment metric parameters, wherein the control module controls the resource module for adjusting the cloud resource according to the at least one environment metric parameters.

10. The cloud system according to claim 1, wherein at least one of the resource module, control module and monitoring module is a daemon performed in a computing device.
